(19) United States
(12) Patent Application Publication
(10) Pub. No.: US 2005/0055861 A1
(43) Pub. Date: Mar. 17, 2005

(54) Message holder

(76) Inventor: Nicholas Paul McAnulty, Vernon (CA)

Correspondence Address: Lance A. Turlock;Meridian Patent Services, #471, 7231-120th Street, Delta, V4C 6P5, CA

(21) Appl. No.: 10/662,814

(22) Filed: Sep. 16, 2003

(51) Int. Cl. G09F 3/18

(52) U.S. Cl. 40/654.01

(57) ABSTRACT

A message holder is disclosed comprising a sheet of pliant material whose front surface comprises a first portion at one end, a second portion at the other end, and an intermediate portion, and whose rear surface comprises a first portion at one and a second portion at the other end. With the exception of the second portion of the front surface which is reserved for displaying a desired message, the various portions of the holder are attachable to one another in various ways with all or at least a portion of the holder wrapped around a pipe, cable or other elongated structure. Differing configurations permitting a message to be displayed are possible and users are able to choose the configuration they prefer or the configuration that is best suited for a given task. As well, two or more of such holders may be connected with each other to display two or more messages in close proxity.

### FIELD OF THE INVENTION

The present invention relates to message holders particularly suitable for use in a variety of industrial and construction settings.

### BACKGROUND TO THE INVENTION

In various settings such as those that may be found in industrial plants, construction sites, and the like, it is often desirable to post effective messages regarding equipment, apparatus and other material that is present on the site, and who to contact if servicing or other attention is required. This is most immediately apparent in relation to safety concerns. For example, in chemical plants some pipes and their contents may become explosive unless handled properly. The replacement of a piping section with inappropriate materials may have disastrous consequences. In some circumstances, an emergency worker assessing priorities may need to quickly ascertain significant information regarding a particular pipe, such as what a pipe is made of, what it normally contains, and who should be contacted if problems arise.

The need for suitable message information has been addressed in a variety of ways. For instance, piping may be color coded to identify the piping material and/or the normal content of the pipe. Alternatively, desired messages may be applied to a pipe or other equipment with stick-on or other labels, or by tags attached with wire, twist ties or other suitable means, or by simply writing an appropriate message on the pipe. However, such systems suffer from various drawbacks.

For example, color or other coding by itself relies on an observer's familiarity with the codes being used. But, coding conventions are not universally known, and lack of knowledge or imperfect memory is a potential source of error or delay. In addition, the information represented by a code can be very limited. This is not to say that color or other coding is undesirable, but it often will not serve to easily convey a significant amount of desired information.

Further, the application of individual labels or other message holders whether by writing on a piece of equipment or by affixation with twist ties, adhesive tape or the like, can lead to a confusing and/or disorderly proliferation or presentation of desired messages. This may impair the ability of an observer to rapidly identify and accurately digest relevant information at a given time.

One object of the present invention is to provide a new and improved message holder suitable for the orderly presentation of message information, and which can be quickly configured in differing ways for attachment to differing sized pipes or other pieces of equipment.

Another object of the present invention is to provide a new and improved holder which can be securely wrapped around a pipe or other piece of equipment while presenting an adequate surface for the proper display of message information.

Yet another object of the present invention is to provide a new and improved message holder which can be linked with other similar message holders so that an orderly series of messages can be presented in close proximity to one another.

### SUMMARY OF THE INVENTION

The present invention provides a message holder that may be wrapped and secured around a pipe or other piece of equipment in at least two configurations. A first configuration allows the holder to be wrapped and secured in a tubular manner that leaves no protruding flaps or other elements. A second configuration permits a portion of the holder to be wrapped and secured but leaves a substantially flat information display area extending from the wrapped portion. In the second configuration, the holder is securable in series with one or more like holders. A series of messages can thereby be assembled at a single location in such a manner that it is relatively easy for an untrained observer to rapidly determine the location of the most pertinent information in the circumstances.

In one broad aspect of the present invention, there is provided a message holder comprising a sheet of pliant material having a front surface and a rear surface; and extending lengthwise between first and second ends and widthwise between opposed sides. The front surface includes a first portion extending from the first end towards the second end, a second portion extending from the second end towards the first end for providing an area for displaying a desired message, and an intermediate portion extending between the first and second portions. The rear surface comprises a first portion extending from the first end towards the second end, and a second portion extending from the second end towards the first end. A first attachment means is attached to the sheet for attaching the first portion of the front surface to the intermediate portion of the front surface. A second attachment means is attached to the sheet for attaching the second portion of the rear surface to the first portion of the rear surface.

In another broad aspect of the present invention, there is provided a message holder as described above, except that the second attachment means is for attaching the second portion of the rear surface to the first portion of the front surface.

Preferably, the aspects of both embodiments described above are combined in a single message holder where the second attachment means serves to attach the second portion of the rear surface, selectively, to either the first portion of the rear surface or to the first portion of the front surface.

Various means may be used to perform the functions of the first and second attachment means. For example, the first and second attachment means may each comprise suitable pressure sensitive adhesive. However, each attachment means preferably comprises one or more attachment pieces, each piece being attached to a designated portion on the front surface or rear surface of the message holder sheet. Most preferably, for durability and repeated use, selected ones of such attachment pieces each comprise a strip of material having attachment loops, while the remaining ones of the attachment pieces each comprise a strip of cooperating material having hooks releasably engageable with said loops. VELCRO™ material is a well known material having such attributes.

In preferred embodiments, specific information to be carried by a given message holder is presented on a message card removably inserted into a display pocket of the holder. In this way, a message can be readily changed or updated without the necessity of changing the holder itself.

The foregoing and other features and advantages of the present invention will now be described with reference to the drawings.

### BRIEF DESCRIPTION OF THE DRAWINGS

FIG. 1 is a front elevation view of a message holder in accordance with the present invention.

FIG. 2 is a side elevation view of the holder shown in FIG. 1.

FIG. 3 is a front perspective view of the holder shown in FIG. 1.

FIG. 4 is a rear perspective view of the holder shown in FIG. 1.

FIG. 5 shows the message holder in FIG. 1 in a first configuration wrapped around a relatively large diameter pipe.

FIG. 6 shows the message holder in FIG. 1 in a second configuration wrapped around a relatively small diameter pipe.

FIG. 7 shows the message holder in FIG. 1 in a third configuration wrapped around a pipe having a diameter smaller than the pipe shown in FIG. 5 but larger than the pipe shown in FIG. 6.

FIG. 8 shows the message holder in FIG. 1 in a fourth configuration similar to that shown in FIG. 7, but wrapped around a pipe in a different manner.

FIG. 9 is a perspective view of an embodiment of the invention comprising a series of holders as shown in FIG. 1, a first one of the holders being wrapped around a pipe in the manner shown in FIG. 6, and additional ones of the holders being connected in succession from the first.

FIGS. 10A and 10B show examples of message cards sized for insertion in the pocket of the message holder shown in FIG. 1.

FIG. 11 is a front perspective view of another message holder in accordance with the present invention.

FIG. 12 is a rear perspective view of the message holder shown in FIG. 11.

### DETAILED DESCRIPTION OF THE INVENTION

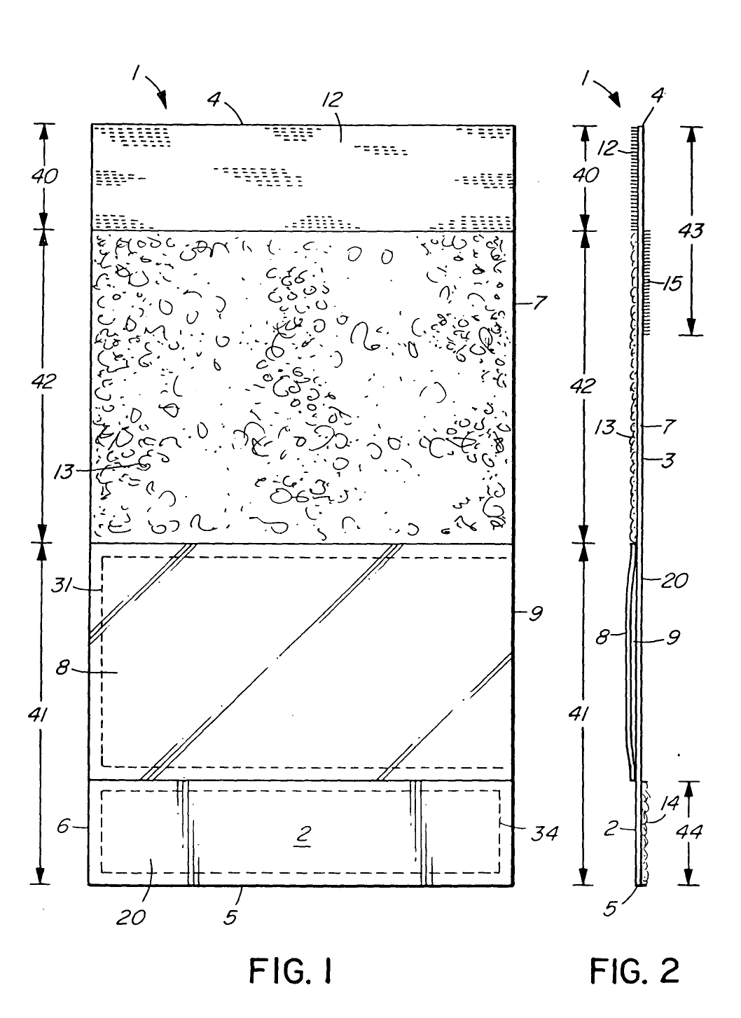

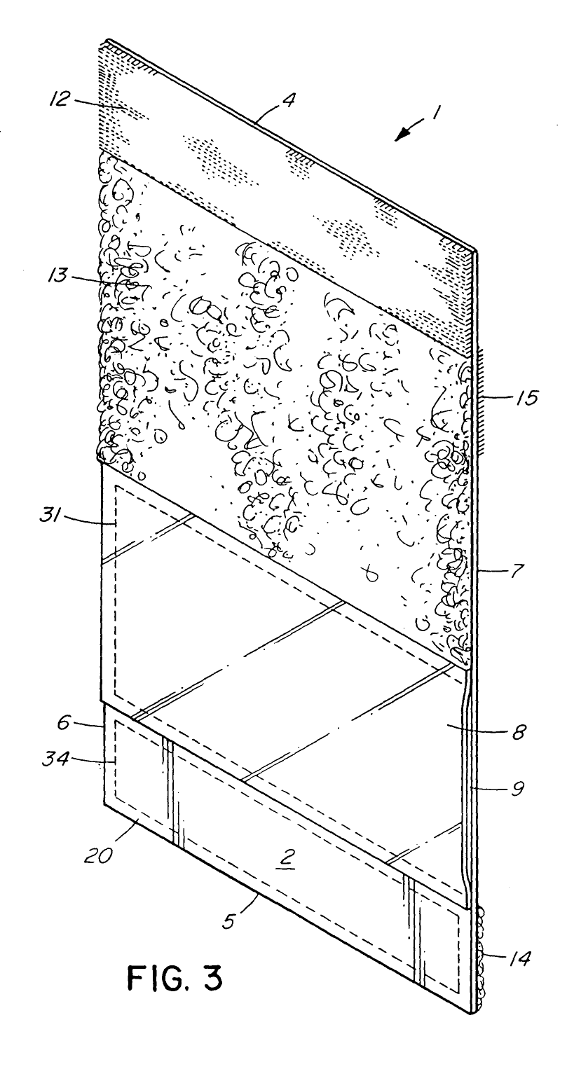

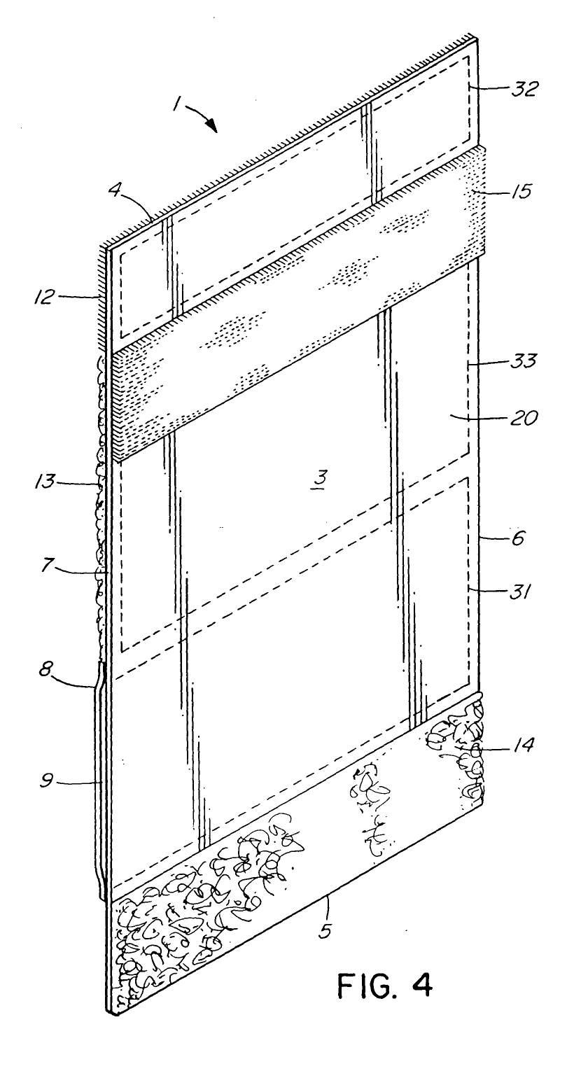

Referring to FIGS. 1-4, the message holder generally designated 1 comprises a sheet of pliant material 20 having a front surface 2 and rear surface 3. As described below, portions of these surfaces are covered by attachment pieces.

Sheet 20 extends lengthwise between first and second ends 4, 5 and widthwise between opposed sides 6, 7. Front surface 2 comprises a first portion 40 extending from end 4 towards end 5, a second portion 41 extending from end 5 towards end 4, and an intermediate portion 42 between the first portion 40 and second portion 41. Rear surface 3 comprises a first portion 43 extending from end 4 towards end 5 and a second portion 44 extending from end 5 towards end 4.

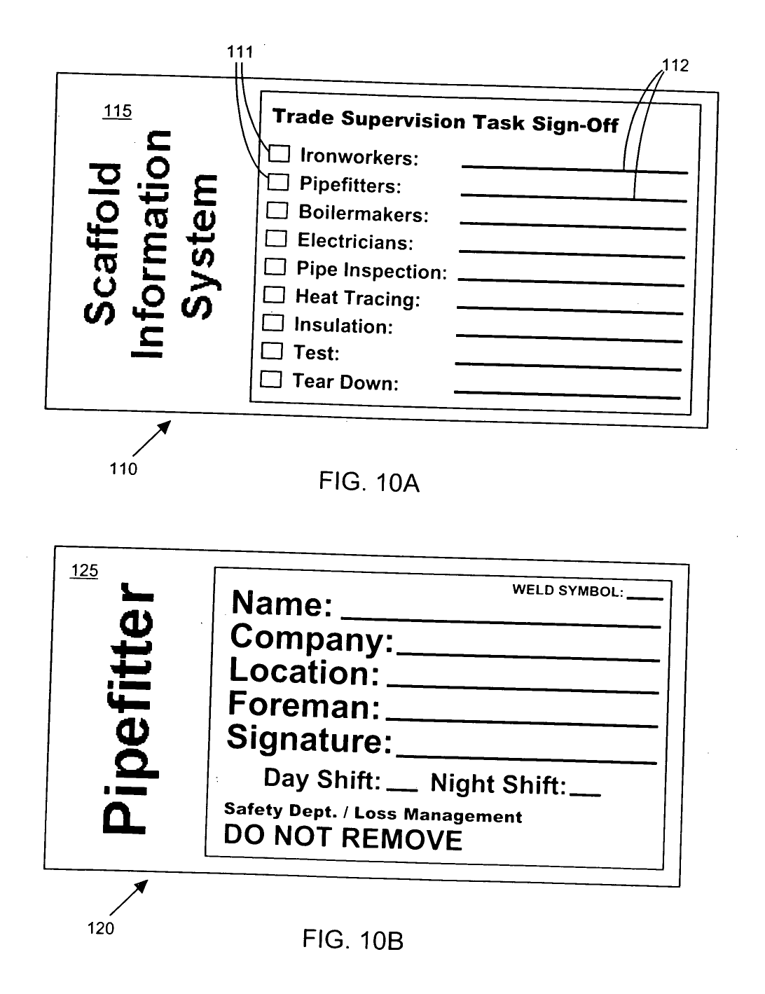

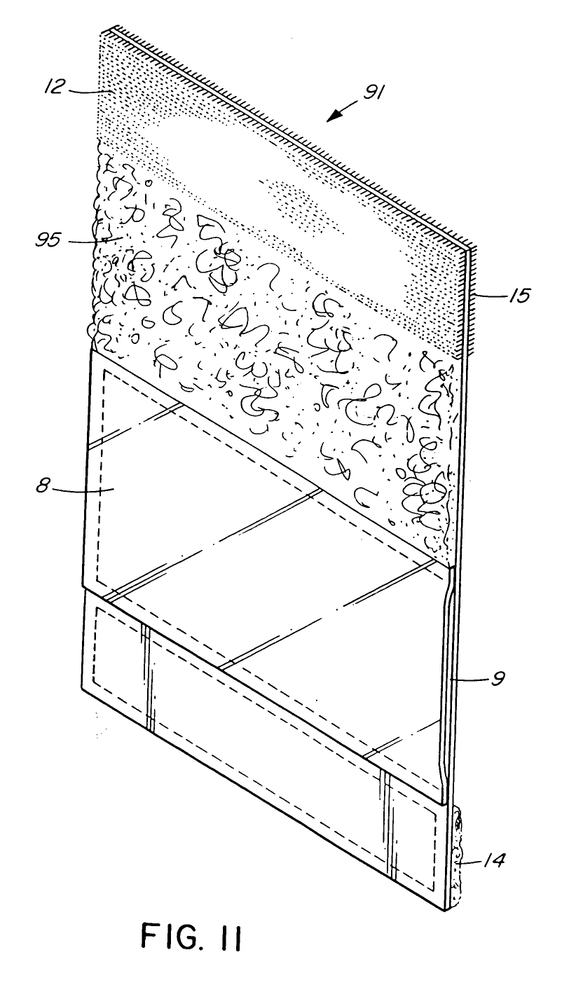

A transparent plastic pocket 8 for holding and displaying a message card (for example, either of message cards 110, 120 shown in FIGS. 10A-10B) is secured by means of stitching 31 to portion 41 of front surface 2. Pocket 8 includes an end opening 9 for receiving or removing a desired message card.

A pocket such as transparent pocket 8 is preferred because it allows a message card to be easily inserted or removed, and because it offers good protection from the surrounding environment. Nevertheless, it will be readily apparent that other means may be used to present a desired message within the area of portion 41 of front surface 2. For example, various types of fastening arrangements (e.g. using VELCRO™ material) could be used to secure a message card to portion 41. Or, for example, a plasticized film with an imprinted message could be secured directly to portion 41 with a suitable adhesive. As well, and provided that the composition of front surface 2 is receptive, a desired message could be written or imprinted directly on sheet 20 within the area of portion 41. However, such alternatives are generally considered less desirable than the use of a simple pocket such as transparent pocket 8 because, if the alternatives do not preclude the substitution of one message for another, they may complicate the task.

To enable use in a wide range of working conditions, sheet 20 preferably is formed from an industrial vinyl which is of low flammability, substantially inert and resistant to marking. It should be resistant to extremes of temperatures, water, oil and the like, and should have UV inhibitors to enhance longevity. However, notwithstanding such preferences, other types of pliant material may be used, including other types of plastic, paper, fabric, etc. Obviously, the suitability of a particular type of material will depend upon the circumstances.

To facilitate the sizing and wrapping of holder 1 into any one of avariety of alternative configurations, several attachment pieces are secured to the front and rear surfaces 2, 3 of sheet 20. More particularly, first and second attachment pieces or strips 12, 13 are attached to front surface 1, and third and fourth attachment pieces or strips 14, 15 are attached to rear surface 2. Attachment piece or strip 12 is secured by means of stitching 32. Attachment piece 13 is secured by mean of stitching 33. Attachment piece 14 is secured by means of stitching 34. Although not visible in the drawings, attachment piece 15 is likewise secured by means of stitching, part of which may include stitching 33 used to secure attachment piece 13. All attachment pieces or strips extend lengthwise between sides 6, 7 for substantially the full width of sheet 20. Each strip has a defined width; that of strip 13 being about 3 times the width of strip 12, that of strips 14 and 15 being about the same as the width of strip 12.

Attachment piece 12 is releasably engageable with attachment piece 13. Attachment piece 14 is releasably engageable, selectively, with either attachment piece 12 or attachment piece 15. Thus, it will be apparent that attachment piece 12 together with attachment piece 13 provides a means for releasably attaching portion 40 of front surface 2 to intermediate portion 42 of front surface 2. Similarly, attachment piece 14 together with either attachment piece 12 or attachment piece 15 provides a means for releasably attaching portion 44 of rear surface 3, selectively, to either portion 40 of front surface 2 or portion 43 of rear surface 3.

In a preferred embodiment, attachment pieces 12, 15 are made from strips of VELCRO™ fastener hook material stitched to sheet 20 and attachment pieces 13, 14 are made from cooperating strips of VELCRO™ fastener loop material likewise stitched to sheet 20.

The dimensions of holder 1 obviously may be varied to suit differing circumstances. However, the following approximate dimensions are considered suitable for a variety of applications:

| | |
|---|---|
| Sheet 20: | 36 cm lengthwise by 20 cm widthwise; |
| Attachment pieces 12, 14, 15: | 20 cm lengthwise by 5 cm widthwise; |
| Attachment piece 13: | 20 cm lengthwise by 15 cm widthwise; |
| Pocket 8 inside dimensions: | 19 cm lengthwise by 10 cm widthwise. |

In the case of attachment pieces or strips 12, 14 and 15, the 5 cm width is not only suitable but also convenient because, at least at the present time, this is a commercially available off the shelf width for VELCRO™ material. In the case of attachment piece 13, the width of 15 cm conveniently can be achieved by placing three 5 cm wide strips side by side to form the equivalent of a single 15 cm wide strip.

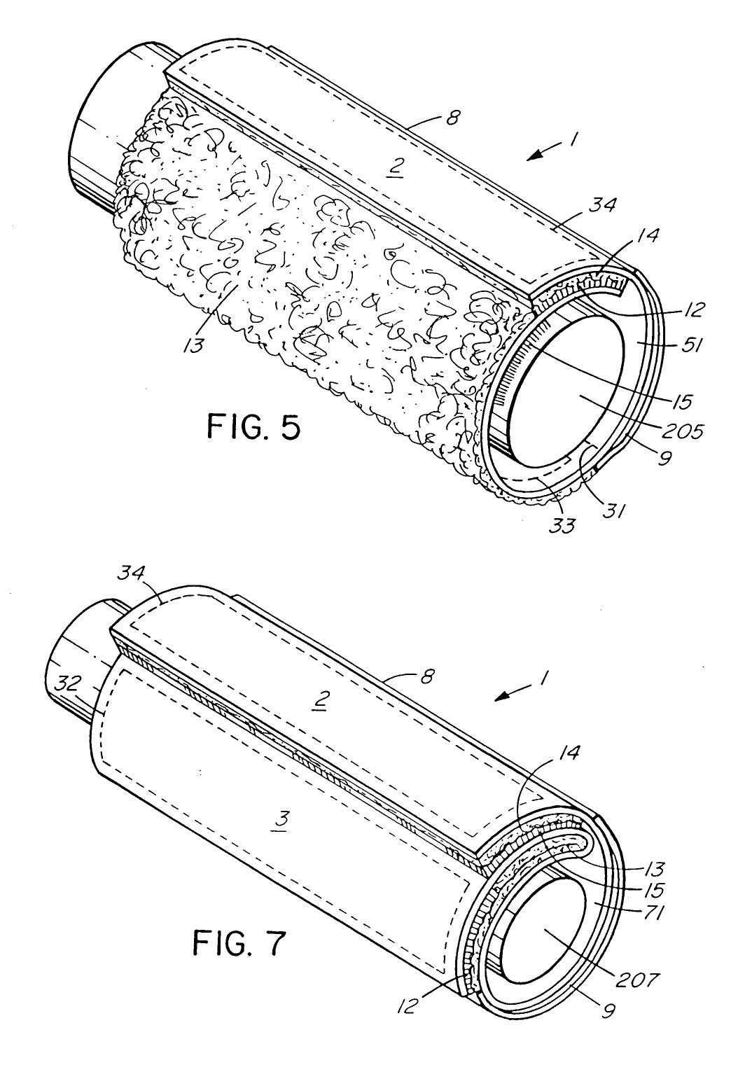

In use, and by suitable opposition of cooperating hooked and looped VELCRO™ strips, holder 1 can be made to adopt a number of different configurations and to suit different modes of use as will now be described with primary reference to FIGS. 5-8.

In a first configuration as illustrated in FIG. 5, the rear surface of sheet 20 is rolled or wrapped towards the front surface around a pipe 205 so that attachment piece 14 is brought into engagement with attachment piece 12. Holder 1 is thereby made to adopt a generally tubular configuration around pipe 205; the pipe extending longitudinally through a channel 51 formed by the holder. Pocket 8 faces outwardly (to the rear in FIG. 5) to display a message card (not shown) inserted therein. To present a suitable angle of view, holder 1 can be rotated on the axis of pipe 205 so that the message card in pocket 8 face more upwardly than downwardly, or more downwardly than upwardly, or at a suitable mid point. The angle of adjustment will depend upon the normal eye level of a viewer. As indicated above, the message card may be similar to either of those shown in FIGS. 10A, 10B or any other appropriate message card.

It should be noted that pipe 205 and other pipes referred to herein are not part of the invention. To the extent that they are shown and described herein, they are shown and described only by way of example. It will be understood that holder 1 may be folded, rolled or wrapped around a number of elongated structures other than pipes (for example, wires, cables, bars, etc.), and that the cross-section need not be circular as in the case of pipes.

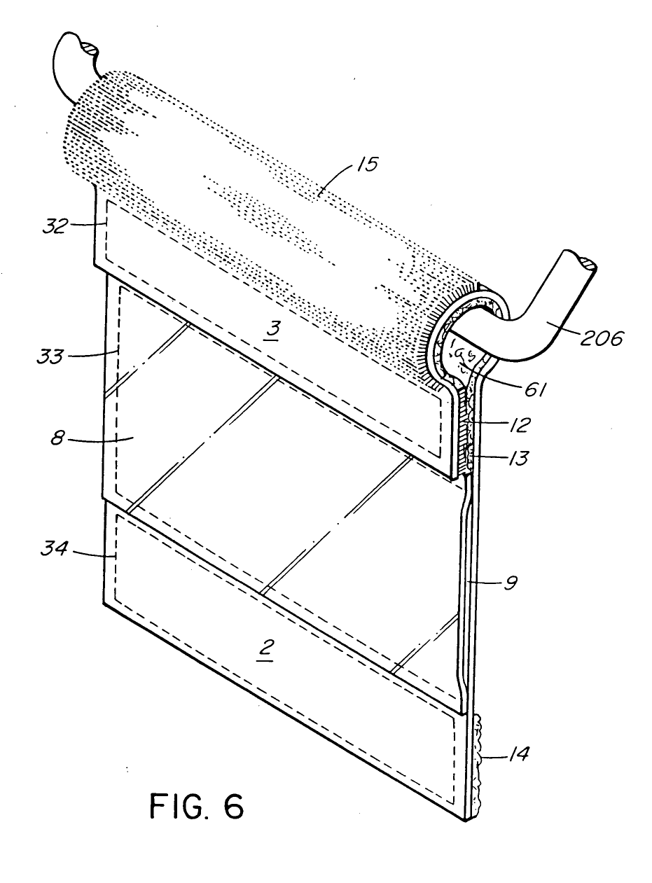

Pipe 205 in FIG. 5 has a relatively large diameter, and it will be apparent that the configuration shown in FIG. 5 provides a maximum circumference for channel 51 in the tubular structure formed by holder 1. In a second configuration as illustrated in FIG. 6, holder 1 is folded and wrapped to more closely accommodate a pipe 206 having a relatively small diameter. More particularly, portion 40 of front face 2 has been folded downwardly and over pipe 205 to bring attachment piece 12 into engagement with the lowermost part of attachment piece 13 on portion 42. Pipe 206 then extends longitudinally through a channel 61 formed by the upper part of holder 1. The holder hangs from pipe 206 such that a substantial lower part of the holder including pocket 8 extends in a flat vertical orientation below the pipe. But, the orientation of the lower part need not be vertical. The configuration of holder 1 as shown in FIG. 6 is also useful in cases where it is desired to label wires or cables (not shown) that are laid out, usually on a temporary basis, across a floor or other horizontal surface (not shown). In these cases, holder 1 can be wrapped around the wire or cable with the configuration shown in FIG. 6 and allowed to lay flatly on the surface with pocket 8 facing upwardly. Vertically, the holder then will have a low profile which minimizes its chances of being snagged by traffic moving across the floor.

In a third configuration as illustrated in FIG. 7, holder 1 is adjusted to adopt a tubular configuration around a pipe 207 which has a diameter less than pipe 205 but greater than pipe 206. Pipe 207 extends longitudinally through channel 71 formed by the holder. Similar to the case of the configuration illustrated in FIG. 5, pocket 8 is displayed on the outer face of the configuration shown in FIG. 7. However, the resultant configuration in FIG. 7 is tubularly more compact than the configuration in FIG. 5.

The configuration shown in FIG. 7 is formed by a two step process. Firstly, sheet 20 is folded forward so that attachment piece 12 on front surface 2 is brought into engagement with the lowermost part of attachment piece 13 on front surface 2. The result is to effectively shorten the overall length of holder 1, and to present attachment piece 15 on rear surface 3 at the front and at the top of the foreshortened holder. Then, the rear surface of sheet 20 is rolled or wrapped around pipe 207 and over the top of the foreshortened holder so that attachment piece 14 is brought into engagement with attachment piece 15.

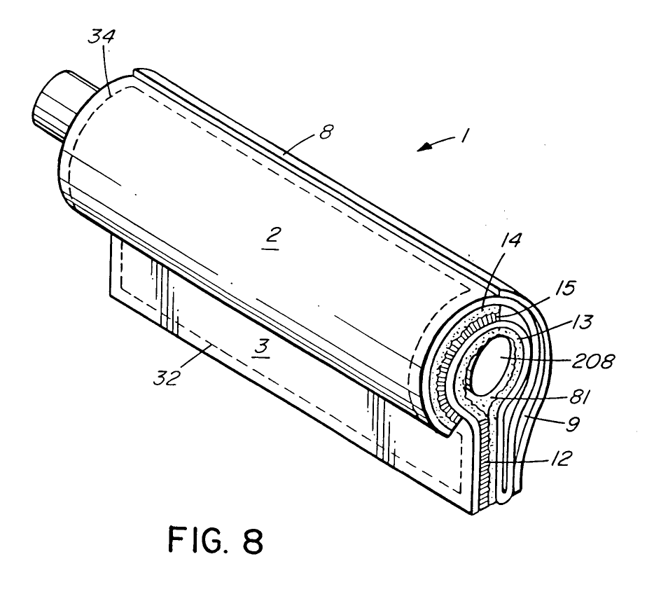

FIG. 8 shows holder 1 in a fourth configuration similar to the third configuration shown in FIG. 7. However, in the case of FIG. 8, a pipe 208 extends through a channel 81 which is longitudinally bounded by the surface of attachment piece 13. Channel 71 through which pipe 207 extends in FIG. 7 is effectively collapsed by the distension of channel 81 in the case of the configuration shown in FIG. 8.

The configuration shown in FIG. 8 is formed by a two step process. Firstly, sheet 20 is folded forward and over pipe 208 so that attachment piece 12 on front surface 2 is brought into engagement with the lowermost part of attachment piece 13 on front surface 2. This step forms channel 81 around pipe 208. As in the case of the configuration shown in FIG. 7, the result is to effectively shorten the overall length of holder 1, and to present attachment piece 15 on rear surface 3 at the front and at the top of the foreshortened holder. Rear surface of sheet 20 then is rolled or wrapped over the top of the foreshortened holder so that attachment piece 14 is brought into engagement with attachment piece 15.

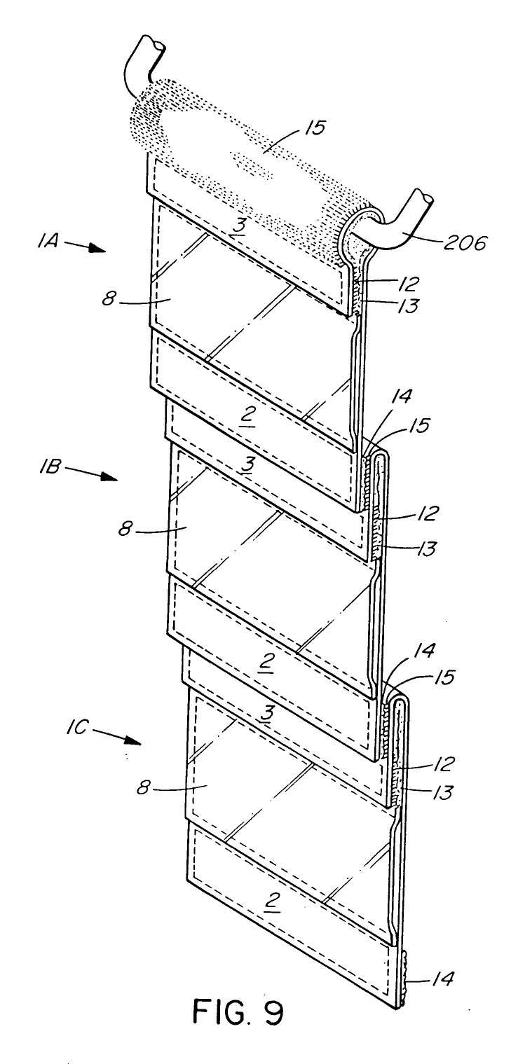

In the embodiment of the invention shown in FIG. 9, a number of holders generally designated 1A, 1B, 1C are connected in succession. Each holder 1A, 1B, 1C is essentially the same in construction as holder 1 discussed above. In relation to FIG. 9, they each have been given unique designations only for the purpose of discussion.

Holder 1A has the same configuration as holder 1 shown in FIG. 6, the upper portion of the holder 1A being wrapped around pipe 206. Accordingly, the configuration of holder 1A will not be discussed further except to note that prior to connection with holder 1B, attachment piece 14 of holder 1A is exposed and facing rearward.

Holder 1B has been folded forwardly so that its attachment piece 12 is brought into engagement with the lowermost part of its attachment piece 13. The overall length of holder 1B is thereby shortened. Prior to connection with holder 1A, this leaves attachment piece 15 of holder 1B exposed and facing forward. Further, and prior to connection with holder 1C, this leaves attachment piece 14 of holder 1B exposed and facing rearward.

Holder 1C is folded in the same manner as holder 1B.

In the assembled condition shown in FIG. 9, attachment piece 15 of holder 1B is engaged with attachment piece 14 of holder 1A. Likewise, attachment piece 15 of holder 1C is engaged with attachment piece 14 of holder 1A. The result is an orderly sequence of holders 1A, 1B, 1C connected in succession with the same orientation, each able to hold and display a unique message card in its pocket 8. One message card may have information relating to one aspect of an equipment item; another relating to another aspect; and another relating to yet another aspect.

The use of holders in succession as shown in FIG. 9 is considered most suitable for cases where the connected holders can hang relatively freely, thus leaving message cards contained within pocket 8 of the holders clearly visible. The actual number of holders that are used obviously will vary depending upon the number of message cards to be individually displayed. In some cases, only two holders may suffice. In other cases, four or more holders may be desired. The use of three holders 1A, 1B, 1C as shown in FIG. 9 is merely an example. In any case, a number of differing messages advantageously may be secured and presented in close proximity with a number of individual holders connected as indicated in FIG. 9.

Thus, it will be apparent that holder 1 has a variety of possible configurations. As well, two or more of such holders may be connected in succession. Hence, users are given a choice of configurations and are able to decide which configuration is best suited for a given task.

In a preferred usage of the present invention where differing messages are to be conveyed to differing trades or professions, holder 1 as well as the message card that it carries are color coded. For example, red may be used designate information for pipefitters, blue for boilermakers, orange for ironworkers, yellow for electricians, and so forth. Yet another color (for example green) may be used to designate information for all persons who may need to use a particular piece of equipment or apparatus (for example scaffolding).

The message cards that holder 1 is designed to hold and display in pocket 8 and the information that may appear thereon are not considered to be part of the present invention. Nevertheless it is useful to briefly discuss with reference to FIGS. 10A and 10B two of the forms that have been contemplated.

FIG. 10A illustrate an example of message card generally designated 110 and used as part of a scaffold information system. Card 110 carries message information for those who may need to use scaffolding (not shown) at a construction site before the scaffolding is torn down. Preferably, surface 115 of the card is a distinctly colored surface (e.g. green). In use, holder 1 containing card 110 in pocket 8 is attached at an appropriate location to the scaffolding. The card identifies different trades (viz. ironworkers, pipefitters, electricians) who may require use the scaffolding. Likewise, the card identifies different activities (viz. pipe inspection, heat tracing, insulation) that may need completion before the scaffolding is torn down. For particular cases, a supervisor or supervisors will indicate in check boxes 111 which trades will in fact require use of the scaffolding and which activities will in fact require completion before the scaffolding is torn down. Depending on the circumstances, some boxes 111 may be left unchecked. Signature lines 112 are provided for the responsible supervisor or supervisors to sign off as each task that has been checked is completed. Once it has been confirmed that each of the individual tasks has been properly completed, the final task marked “Tear Down” is checked and signed by the person responsible for the confirmation. Card 110 then may be saved for record purposes and the message holder then may be used for other purposes. The use of such a system can greatly increase the efficiency of use of scaffolding as it avoids the disorganization which may result if scaffolding is repeatedly erected and prematurely torn down through lack of coordination between responsible administrators and supervisors.

FIG. 10B illustrates an example of a message card generally designated 120 which carries information restricted to pipefitters. Preferably surface 125 of the card is a distinctly colored. For example, if used, in the proximity of card 110 which is colored green, then card 120 may be colored red. The contemplated information message information on card 120 includes a specific pipefitter “Name”, a “WED SYMBOL”, and additional details including “Company”, “Location”, “Foreman”, and whether they are on “Day Shift” or “Night Shift”. Such information, posted in holder 1 at an appropriate location can avoid the need to consult central work records to identify responsible parties if the need to do so should arise.

The embodiment of the invention shown in FIGS. 1-4 is considered to be particularly versatile. However, a variety of other embodiments are possible.

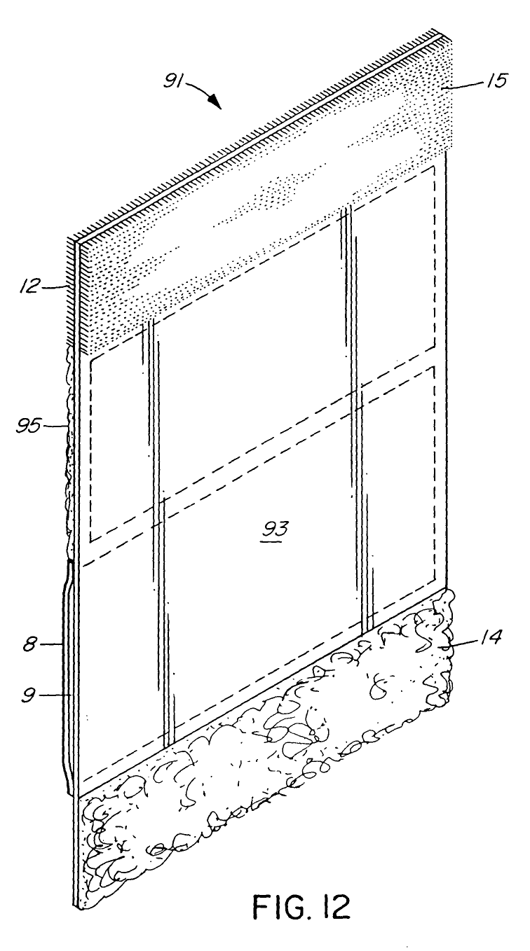

For example, FIGS. 11 and 12 show an alternative embodiment for a message holder generally designated 91 wherein attachment piece 15 as shown for holder 1 in FIGS. 2-4 has been moved to the extreme upper end of the rear surface 93 of holder 91. As well, attachment piece 13 which appears in FIGS. 1-4 has been reduced in width by about ⅓ and is identified in FIG. 11 as attachment piece 95. The overall length of holder 91 has been reduced by a like amount. It will be apparent that if holder 91 may be configured in differing ways similar to those shown in FIGS. 5-8 for holder 1. But the end result will be tubularly more compact. Such changes to the specific design of the holder 1 are a matter of convenience and it will be apparent that to suit specific applications it may be desirable to adjust the precise locations and dimensions of particular attachment pieces and particular portions of the front and rear surfaces.

More generally, it should be understood that numerous changes to the embodiments of the invention illustrated in the drawings are possible within the scope of the present invention.

For example, materials or mechanisms other than VELCRO™ fastening material obviously could be used to facilitate engagement between the same or different surfaces. For example, with a holder like holder 1, attachment pieces 13 and 14 may be omitted to expose the full area of intermediate portion 42 of front surface 2 and the full area of portion 44 of rear surface 3. Pressure sensitive adhesive suitable for engaging such exposed areas may be substituted for attachment pieces 12 and 15. Or, the roles may be reversed by omitting attachment pieces 12 and 15 and substituting pressure sensitive adhesive for attachment strips 13 and 14.

Also, it will be recognized that while attachment pieces 12, 13, 14, 15 as shown in the drawings are formed as integral pieces within given areas, each could be formed as a group of discrete pieces in the same general areas with the discrete pieces either abutting or displaced from one another.

More generally, a variety of modifications, changes and variations to the invention as described and illustrated with reference to the drawings are possible within the spirit and scope of the following claims, and will undoubtedly occur to those skilled in the art. The invention should not be considered as restricted to the specific embodiments that have been described and illustrated.

1. A message holder, comprising:
(a) a sheet of pliant material having a front surface and a rear surface; said sheet extending lengthwise between first and second ends and widthwise between opposed sides, said front surface comprising:
(i) a first portion extending from said first end towards said second end;
(ii) a second portion extending from said second end towards said first end, said second portion for providing an area for displaying a desired message; and,
(iii) an intermediate portion extending between said first and second portions;
said rear surface comprising:
(i) a first portion extending from said first end towards said second end; and,
(ii) a second portion extending from said second end towards said first end;
(b) a first attachment means attached to said sheet for attaching said first portion of said front surface to said intermediate portion of said front surface; and,
(c) a second attachment means attached to said sheet for attaching said second portion of said rear surface to said first portion of said rear surface.

2. A message holder, comprising:
(a) a sheet of pliant material having a front surface and a rear surface; said sheet extending lengthwise between first and second ends and widthwise between opposed sides, said front surface comprising:
(i) a first portion extending from said first end towards said second end;
(ii) a second portion extending from said second end towards said first end, said second portion for providing an area for displaying a desired message; and,
(iii) an intermediate portion extending between said first and second portions;
said rear surface comprising:
(i) a first portion extending from said first end towards said second end; and,
(ii) a second portion extending from said second end towards said first end;
(b) a first attachment means attached to said sheet for attaching said first portion of said front surface to said intermediate portion of said front surface; and,
(c) a second attachment means attached to said sheet for attaching said second portion of said rear surface to said first portion of said front surface.

3. A message holder, comprising:
(a) a sheet of pliant material having a front surface and a rear surface; said sheet extending lengthwise between first and second ends and widthwise between opposed sides, said front surface comprising:
(i) a first portion extending from said first end towards said second end;
(ii) a second portion extending from said second end towards said first end, said second portion for providing an area for displaying a desired message; and,
(iii) an intermediate portion extending between said first and second portions;
said rear surface comprising:
(i) a first portion extending from said first end towards said second end; and,
(ii) a second portion extending from said second end towards said first end;
(b) a first attachment means attached to said sheet for attaching said first portion of said front surface to said intermediate portion of said front surface; and,
(c) a second attachment means attached to said sheet for attaching said second portion of said rear surface, selectively, to either said first portion of said rear surface or to said first portion of said front surface.

4. A message holder as defined in claim 1, 2, or 3, wherein said first and second attachment means each comprise pressure sensitive adhesive material.

5. A message holder as defmed in claim 1, wherein:
(a) said first attachment means comprises:
(i) a first attachment piece attached to said first portion of said front surface; and,
(ii) a second attachment piece attached to said intermediate portion of said front surface,
said first attachment piece being releasably engageable with said second attachment piece; and,
(b) said second attachment means comprises:
(i) a third attachment piece attached to said second portion of said rear surface; and,
(ii) a fourth attachment piece attached to said first portion of said rear surface,
said third attachment piece being releasably engageable with said fourth attachment piece.

6. A message holder as defined in claim 2, wherein:
(a) said first attachment means comprises:
(i) a first attachment piece attached to said first portion of said front surface; and,
(ii) a second attachment piece attached to said intermediate portion of said front surface,
said first attachment piece being releasably engageable with said second attachment piece; and,
(b) said second attachment means comprises a third attachment piece attached to said second portion of said rear surface, said third attachment piece being releasably engageable with said first attachment piece.

7. A message holder as defined in claim 3, wherein:
(a) said first attachment means comprises:
(i) a first attachment piece attached to said first portion of said front surface; and,
(ii) a second attachment piece attached to said intermediate portion of said front surface,
said first attachment piece being releasably engageable with said second attachment piece; and,
(b) said second attachment means comprises:
(i) a third attachment piece attached to said second portion of said rear surface; and,
(ii) a fourth attachment piece attached said first portion of said rear surface,
said third attachment piece being releasably engageable, selectively, with said first attachment piece or with said fourth attachment piece.

8. A message holder as defmed in claim 5, 6 or 7, wherein selected ones of said attachment pieces each comprise a strip of material having attachment loops, and wherein the remaining ones of said attachment pieces each comprise a strip of cooperating material having hooks releasably engageable with said loops.

9. A message holder as defined in any one or more of the preceding claims, further including a pocket secured to said second portion of said front surface for holding and displaying a message card.

10. A plurality of message holders as defined in claim 5, each of said message holders including an associated pocket secured to said second portion of said front surface of the holder for holding and displaying a desired message, said message holders being connected in a succession where the fourth attachment piece of each message holder in the succession after the first message holder in the succession is engaged with the third attachment piece of the immediately preceding message holder in the succession.

11. A plurality of message holders as defined in claim 7, each of said message holders including an associated pocket secured to said second portion of said front surface of the holder for holding and displaying a desired message, said message holders being connected in a succession where the fourth attachment piece of each message holder in the succession after the first message holder in the succession is engaged with the third attachment piece of the immediately preceding message holder in the succession.
